(19) United States
(12) Patent Application Publication
(10) Pub. No.: US 2009/0187300 A1
(43) Pub. Date: Jul. 23, 2009

(54) Integrated vehicle computer system

(76) Inventors: David Wayne Everitt, Laveen, AZ (US); Reed L. Porter, Santa Clara, CA (US); Anthony Veasna Chan, San Jose, CA (US)

Correspondence Address: JONES DAY, 555 SOUTH FLOWER STREET FIFTIETH FLOOR, LOS ANGELES, CA, 90071, US

(21) Appl. No.: 12/009,941

(22) Filed: Jan. 22, 2008

(51) Int. Cl. G01C 21/36; G06F 17/40; G06F 19/00; G08G 1/052; G06F 3/048

(52) U.S. Cl. 701/29; 701/213; 701/201; 701/300; 701/119; 715/769

(57) ABSTRACT

An integrated vehicle computer system is provided. The features of the integrated vehicle computer system include a video based vehicle/driver security system that delivers immediate incident notification, turn-by-turn GPS navigation, live visual traffic grids with links to live freeway cameras, internet access and mobile wireless hub capability, email, internet music service navigation, internet radio station navigation, and MP3 or digital file library selection. One of potential application of the integrated vehicle computer system is to passage vehicles.

### BACKGROUND

1. Technical Field

The application generally relates to computer systems installed on vehicles. In particular, it is directed to computer systems installed on vehicles that provide security to the vehicles, to people on board, and to remote sites where the vehicle is located.

2. Description of Related Art

Various types of electronics devices or computer systems have been used in vehicles, including GPS navigation systems, theft recovery systems, vehicle security systems, driver behavior monitoring systems, and in-car entertainment systems. These systems are developed for a variety of purposes, including making vehicles safer, more theft resistant, and more comfortable. Some examples of these systems will be discussed hereafter.

LoJack Stolen Vehicle Recovery System is equipped with a transmitter which can be installed in a secret location in a vehicle. If the vehicle is stolen, the owner of the vehicle may notify the police who may subsequently activate a computer system that emits a radio signal to turn on the stolen vehicle's transmitter. Police cars equipped with receivers pick up the vehicle's signal and the police are able to identify the stolen vehicle's location.

OnStar, a General Motors subsidiary, provides subscription-based in-vehicle security, communications and diagnostics services throughout the United States and Canada. OnStar utilizes Verizon's wireless network for communications between a service center and its subscribers. An OnStar service center monitors vehicle diagnostic data and reacts to a traffic accident by continually tracking the location of a vehicle. When there is a request by the subscriber, an operator of the OnStar service center can speak with the vehicle occupants via Verizon's wireless network and provide necessary assistance, such as turn-by-turn navigation or unlocking the vehicle door through the wireless network.

While OnStar fills a need for rapid emergency response, the public is aware that a third party, the service center, monitors a vehicle's location and performance. Although OnStar is able to monitor a vehicle and provide diagnostics and impact data, it does not provide visual information of an accident to its subscribers.

DriveCam, Inc., a San Diego based company, utilizes a video camera in an attempt to take a more preventative approach to alter a driver's behavioral patterns. A DriveCam user places in front of the rear view mirror a low resolution, forward-facing video camera to monitor the upcoming roadway, and a backward-facing camera to monitor the driver. DriveCam is able to detect the driver's behavior such that an adjustment may be made. For example, if an incident condition such as a sudden turn, a quick breaking, or a collision is detected, the cameras capture and store the event for later review by a DriveCam event analysis center. DriveCam's approach seeks to mitigate risk by improving a driver's behavior, which is monitored, and by assessing liability in collisions.

The technology behind DriveCam is a recording device and two digital cameras that capture twenty seconds of video—ten seconds before and ten seconds after an incident—at a resolution of 256×200 pixels and a frame rate of four frames per second. This data is then reviewed by the DriveCam event analysis center. The DriveCam staff may then provide advice to the driver on areas of improvement and may also offer training.

Still, the technologies of both OnStar and DriveCam do not fully address the needs for driver safety. Even worse, the involvement of a service center or an event analysis center in these systems increases the worry from the public that “big brother is watching.”

Existing mobile digital video recorders do not provide features adapted for use in a vehicle. For example, mobile digital video recorders made by Pioneer and Siemens are simple replicas of stationary, land-based models. They are large in size and usually require a 110 volts power supply that limits their use in a vehicle since the power supply in a vehicle is typically 12 volts. Another drawback of these mobile digital video recorders is that they work only when the car engine in running.

Some commercial in-car accident recorders were developed to solve power supply and size problems of a mobile digital video recorders previously described.

TruScene's TS-1L is a single lens camera unit that can be mounted on the front windscreen or the rear screen of a vehicle. The camera unit is powered by the vehicle battery so that the camera works as long as the battery is charged. The camera unit can be integrated into a vehicle ignition GPS system that allows for the time and location of the footage to be embedded onto the clip. The video clips from the camera simultaneously record onto memory loops approximately every thirty seconds. The memory loops are continuously written over by new video images. If the vehicle is involved in an accident that results in a pre-determined G-force, then a G-force motion sensor is activated and the video image is transferred to a non-volatile memory for storage and later usage.

Similarly, Clarion's DriveEye is also an in-car accident recorder that can be used to record the surrounding environment of a vehicle and record a twenty-second video clip when an accident is happening. The DriveEye camera can be mounted or clamped on a vehicle's windshield to record a front view of the vehicle. A G-force sensor is used in DriveEye to detect a sudden stop or acceleration of the vehicle. Upon sensing a sudden stop or acceleration, DriveEye saves fifteen seconds of video clip before the incident and five seconds afterward. The twenty seconds of video may be used as evidence of what happened just before and after an incident.

Another example of an in-car accident recorder is Fujitsu's Eclipse, which has a similar function as TruScene's TS-1L and Clarion's DriveEye. But although these in-car accident recorders can take video clips before and after an incident, that is also the only function they provide.

Therefore, a need continues to exist for an improved in-vehicle computer system that provides a solution to the above-mentioned drawbacks of “big brother” monitoring, and power/recording deficiencies. In addition, the in-vehicle computer system preferably should empower drivers with recordings they can use as they choose. The end user control of the video footage until he or she chooses to release it.

### SUMMARY

An exemplary integrated vehicle computer system is disclosed. Potential applications of the exemplary integrated vehicle computer system include passenger vehicles, commercial vehicles, public safety vehicles, school buses, recreational vehicles, marine vehicles, and motorcycles.

The exemplary integrated vehicle computer system takes state of the art digital video recorder technologies, computers, wireless communications, human interfaces, and internet technologies and combines them within a miniaturized platform. Drivers interact simply, easily, and safely with an interface that combines a video-based security system to deliver an immediate incident notification. The exemplary integrated vehicle computer system also provides turn-by-turn GPS navigation, live visual traffic grids with links to live freeway cameras, internet access and mobile wireless hub capability, email access, internet music service navigation, internet radio station navigation, MP3 library navigation and the like. The open design approach of the exemplary integrated vehicle computer system provides an in-vehicle computing platform that is simple to use and can grow to accommodate almost any application for personal, public safety, and commercial usage.

The exemplary integrated vehicle computer system is a self-monitoring system. Unlike OnStar and DriveCam, the exemplary integrated vehicle computer system respects the privacy of an user by allowing the user to define how the in-vehicle computer system will behave, when the notification of an incident should be sent, and who should be notified. A third party service center is not required in the system—big brother is not watching.

The exemplary integrated vehicle computer system provides the driver and passengers with security and safety while maintaining a level of privacy expected by the user. The exemplary integrated vehicle computer system assists users according to their expectation and intent. For example, parents can set their own thresholds for their young drivers and can be notified when a situation exceeds any of these thresholds. In case of an accident, parents may be notified immediately and will be able to provide remote access to the vehicle. The functions of immediate notification, video footage, and two-way communications provide the information desired by both the young driver and the parents.

The exemplary integrated vehicle computer system is fully functional even when the car engine is turned off. The self-monitoring features of the exemplary integrated vehicle computer system continue to remain alert, and the system can send a notification immediately upon an unexpected incident, such as automobile theft, opening doors, collisions, towing, and movements that are detected within a camera's field of view or with an accelerometer or other sensor. In a preferred embodiment, the exemplary integrated vehicle computer system immediately sends notification of an “unauthorized incident” that allows users to track vehicles via GPS, watch the camera views from any internet computer, web enabled cell phone, or PDA, and, in the case of theft, even speak to the thieves.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention

FIG. 1 is a block diagram illustrating system components of an exemplary integrated vehicle computer system.

FIG. 2A is a diagram illustrating an exemplary dashboard monitor of the exemplary integrated vehicle computer system of FIG. 1.

FIG. 2B is a diagram illustrating another exemplary dashboard monitor of the exemplary integrated vehicle computer system of FIG. 1.

FIG. 3A is a diagram illustrating an exemplary navigator of the exemplary integrated vehicle computer system of FIG. 1.

FIG. 3B is a diagram illustrating another exemplary navigator of the exemplary integrated vehicle computer system of FIG. 1.

FIG. 4 is a diagram illustrating an interior view in an exemplary vehicle, which is equipped with the set up of the exemplary integrated vehicle computer system of FIG. 1.

FIG. 5 is a block diagram illustrating system components of the video/audio controller in the video/audio capture system of the exemplary integrated vehicle computer system of FIG. 1.

FIG. 6A is a diagram illustrating a perspective view of one embodiment of camera socket of the exemplary integrated vehicle computer system of FIG. 1.

FIG. 6B is a diagram illustrating a front view of the camera socket of FIG. 6A.

FIG. 6C is a diagram illustrating a left side view of the camera socket of FIG. 6A.

FIG. 6D is a diagram illustrating a right side view of the camera socket of FIG. 6A.

FIG. 6E is a diagram illustrating a perspective view of another embodiment of camera socket of the exemplary integrated vehicle computer system of FIG. 1.

FIG. 7 is a diagram illustrating an exemplary vehicle set up with the exemplary integrated vehicle computer system of FIG. 1.

### DETAILED DESCRIPTION

Embodiments of the present disclosure are described herein in the context of an integrated vehicle computer system. Those of ordinary skill in the art will realize that the following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

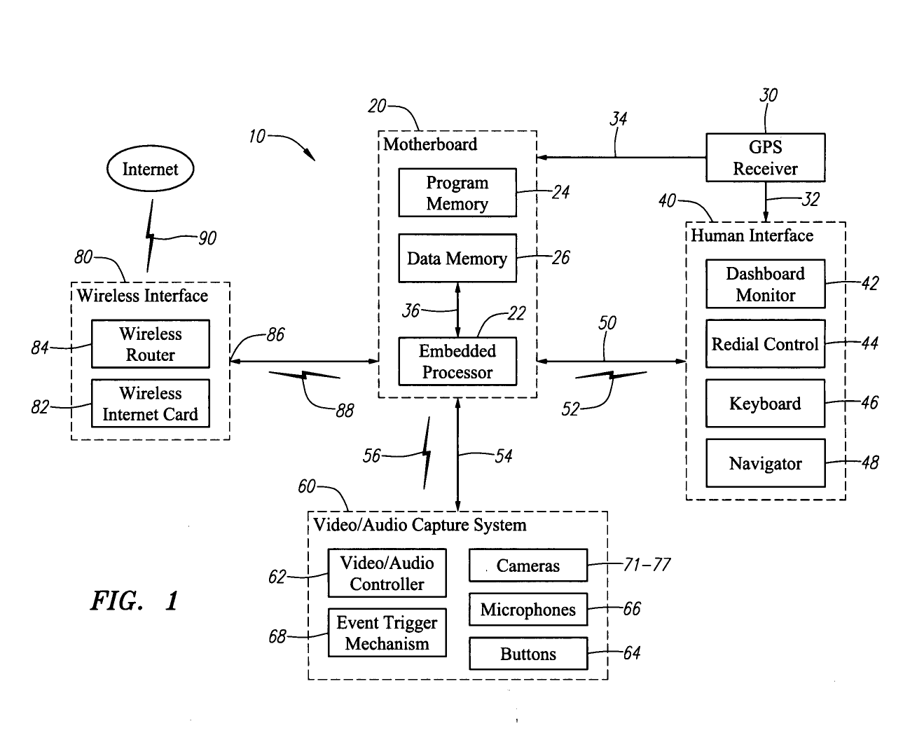

FIG. 1 is a block diagram illustrating system components of an exemplary integrated vehicle computer system 10. In the embodiment illustrated in FIG. 1, the exemplary integrated vehicle computer system 10 is comprised of at least one motherboard 20, a GPS receiver 30, a human interface 40, a video/audio capture system 60, and a wireless interface 80.

According to one embodiment, the motherboard 20 has an embedded processor 22, a program memory 24 and a data memory 26. In one embodiment, the embedded processor 22 can be a microprocessor, a micro-controller, or a digital signal processor that executes one or more instructions contained in the program memory 24. Data in binary format can be stored and retrieved from the data memory 26 through a data bus 36.

The program memory 24 may take many forms, including, but not limited to, floppy disk, hard disk, CD-ROM, ROM, PROM, EPROM, EEPROM, flash memory, or any other medium from which the embedded processor 22 can read.

The data memory 26 may take many forms, including, but not limited to, floppy disk, hard disk, SRAM, DRAM, flash memory, or any other medium from which the embedded processor 22 or other system components 30, 40, 60, 80 can read or write.

In alternative embodiments, hard-wired circuitry may be used in place of or in combination with software instructions to implement the motherboard 20 described herein. Thus, motherboard 20 described herein is not limited to any specific combination of hardware circuitry and software.

According to one embodiment, the human interface 40 includes a dashboard monitor 42, a redial control 44, a keyboard 46, and a navigator 48. Each of the dashboard monitor 42, the redial control 44, the keyboard 46, and the navigator 48 is able to send or receive signals to or from the embedded processor 22 or the data memory 26 through a wired data bus or cable 50. In one embodiment, the wired data bus or cable 50 is a USB cable.

Alternatively, each of the dashboard monitor 42, the redial control 44, the keyboard 46, and the navigator 48 is able to be connected to the embedded processor 22 or the data memory 26 through a wireless connection 52. In one embodiment, the wireless connection 52 is a short distance wireless connection. Some examples of short distance wireless connections are the Bluetooth standard, a wireless USB, and an infrared connection.

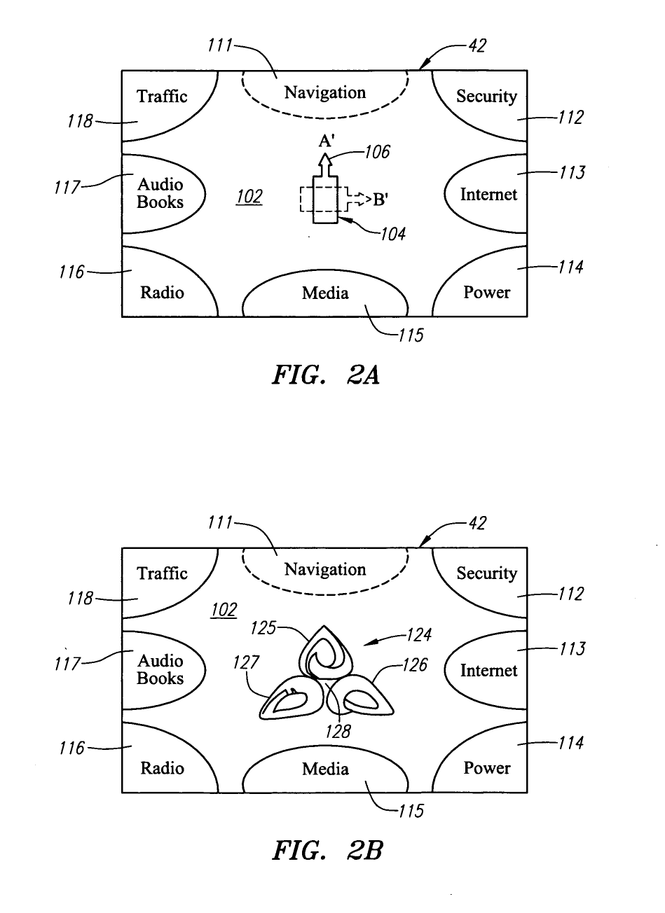

FIG. 2A is a diagram illustrating an exemplary dashboard monitor 42 of the exemplary integrated vehicle computer system 10 of FIG. 1. In the embodiment illustrated in FIG. 2A, the exemplary dashboard monitor 42 serves as a graphic user interface which has a touch screen 102 that is able to display information requested by a user and receive commands from the user.

The exemplary display illustrated in FIG. 2A is a top level manual of the exemplary integrated vehicle computer system 10. In FIG. 2A, a cursor 104 is fixed in the middle of the touch screen 102 but is able to rotate when requested. The cursor 104 has an arrowhead 106 points to one of eight exemplary features 111-118 of the exemplary integrated vehicle computer system 10. It is understood that the number of features can be more than eight if desired.

The exemplary features illustrated in FIG. 2A includes Navigation 111, Security 112, Internet 113, Power 114, Media 115, Radio 116, Audio Books 117, and Traffic 118. These eight exemplary features are shown for the purpose of illustrative purpose. It is understood that any order or combination of these features 111-118 are acceptable. Also, any feature shown in FIG. 2A can be replaced or re-configured by a new feature. These eight exemplary features 111-118 can be performed by the exemplary integrated vehicle computer system 10 when a command or a sequence of commands are entered and accepted by the system 10. Other features may also be incorporated into the system 10 as desired. When one of the eight exemplary features 111-118 is pointed at by the cursor 104, a different color is shown on the pointed exemplary feature. In one embodiment, the color of an un-pointed feature is silver and the color of a pointed feature is blue. In the embodiment illustrated in FIG. 2A, the feature of Navigation 111 is pointed and shown in dashed line for the purpose of illustration of the visually highlight so that the pointed feature of Navigation 111 would be distinguished from the other seven features. The pointed feature may be selected by means as discussed below.

FIG. 2B is a diagram illustrating another exemplary dashboard monitor 42 of the exemplary integrated vehicle computer system 10 of FIG. 1. In the embodiment illustrated in FIG. 2B, the setup is similar to that of FIG. 2A except that the cursor 124 has three arrowheads 125, 126, 127 such that the direction of each arrowhead is separated from other two by 120°. The arrowheads 125, 126, 127 rotate either clockwise or counterclockwise according to a central point 128 which is fixed around the center of the touch screen 102.

In the embodiment illustrated in FIG. 2B, the arrowhead 125 is used as the main indicator. When one of the eight exemplary features 111-118 is pointed at by the arrowhead 125, a different color is shown on the pointed exemplary feature.

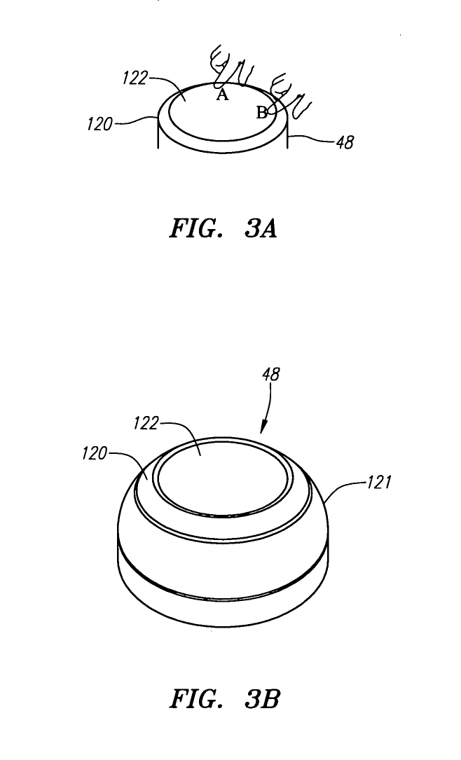

Besides using a computer mouse or a navigator (such as 48 of FIG. 3A and FIG. 3B) to manipulate the selection of features on the touch screen 102, the user can also use a combination of touches on the touch screen 102 to order a command to the system 10. For example, the user may click on one of the features 111-118 on the touch screen 102 to indicate that the feature is selected and a secondary screen will be displayed accordingly. In one embodiment, double clicks on the touch screen 102 places a “zoom-in command” and a zoom-in on the current screen is executed.

According to one embodiment, the redial control 44 is a dial/redial method capable of automatically recreating a list of phone number entries initially stored within a user's cell phone or a list of outbound calls from prior failed call attempts and initiates a redialing process according to the user setup. When the redial control 44 button is pushed, the list of outbound calls may be displayed on the touch screen 102 for the user to select and the system 10 may dial the selected number accordingly. Alternatively, the system 10 may use an interactive voice interface to request a voice command from the user to select a number to call. In another embodiment, the dial/redial function can be integrated into the navigator 48 such that when the navigator 48 button is pushed, the list of outbound calls may be displayed on the touch screen 102 for the user to select and the system 10 would dial the selected number accordingly.

According to one embodiment, the keyboard 46 is a set of push buttons used to input text or characters to control the operation of the exemplary integrated vehicle computer system 10. A standard computer keyboard such as the 104-key PC US English Qwerty keyboard can be used. Other keyboard layouts can also be used. The keyboard 46 can be wirelessly connected to other parts of the exemplary integrated vehicle computer system 10 so as to increase the flexibility of its usage. In one embodiment, the wireless connection between the keyboard 46 and the other parts of the system 10 is a short distance wireless connection.

FIG. 3A is a diagram illustrating an exemplary navigator 48 of the exemplary integrated vehicle computer system 10 shown in FIG. 1. In the embodiment illustrated in FIG. 3A, the navigator 48 has a shape of a round button 120 such that when the navigator 48 is pushed or dragged on the round top surface 122, the arrowhead 106 of the cursor 104 on the touch screen 102 in FIG. 2A also follows. For example, when the top surface 122 of the navigator 48 is pushed or dragged to the 12 o'clock direction as shown in position A, the arrowhead 106 of the cursor 104 on the touch screen 102 in FIG. 2A also points to position A′ and the color of the pointed at feature (i.e., Navigation 111) is highlighted (shown in dashed line for the purpose of illustration) to be distinguished from other un-pointed at features. A confirmation of selection can be performed by another push on the top center portion of the navigator 48 and a second level screen will be shown on the touch screen 102. When the touch screen 102 in FIG. 2A is shown and the top surface 122 of the navigator 48 of FIG. 3A is pushed or dragged to the 3 o'clock direction as shown in the B position, the arrowhead 106 of the cursor 104 on the touch screen 102 in FIG. 2A also points to the B′ position and the color of the pointed at feature (i.e., Internet 113) will be highlighted to distinguish itself from other un-pointed features (not shown). In a similar manner, the exemplary navigator 48 of FIG. 3A is able to control the pointed at direction of the main arrowhead 125 of FIG. 2B and the pointed at feature is highlighted in a different color to distinguish from other un-pointed at features. In this example, Navigation 111 is pointed at by the arrowhead 125 and is shown in dashed line for the purpose of illustration.

FIG. 3B is a diagram illustrating another exemplary navigator 48 of the exemplary integrated vehicle computer system 10 shown in FIG. 1. In the embodiment illustrated in FIG. 3B, the navigator 48 has a round top button 120 and a rotatable side ring 121. When the round top surface 122 of the navigator 48 is pushed or dragged, the arrowhead 106 of the cursor 104 on the touch screen 102 in FIG. 2A also follows and the color of the pointed at feature (i.e., Navigation 111) is highlighted (shown in dashed line for the purpose of illustration). A confirmation of selection can be performed by another push on the top center portion of the navigator 48 and a second level display will be shown on the touch screen 102. When the side ring 121 of the navigator 48 is turned clockwise, the touch screen 102 in FIG. 2A is zoomed in upon, and when the side ring 121 of the navigator 48 is turned counterclockwise, the touch screen display 102 in FIG. 2A zooms. In a similar manner, the exemplary navigator 48 of FIG. 3B is able to control the direction the main arrowhead 125 of FIG. 2B points in and the pointed-at feature (i.e. Navigation 111) is highlighted in a different color. Alternatively, a commercial controller, such as, for example, Logitech's NuLOOQ navigator, that provides navigating functions can be used to replace the navigator 48 shown in FIG. 3B.

In the embodiment illustrated in FIG. 2A, if a user intends to select the feature pointed at by the arrowhead 106 of the cursor 104 in FIG. 2A, he can then push the navigator 48 itself to make a selection. A new screen display will be shown accordingly. If the user intends to select other features, the user can touch the top surface 122 of the navigator 48 to change the direction of the cursor 104. Once the intended feature is selected, he can push the navigator 48 again to make the selection.

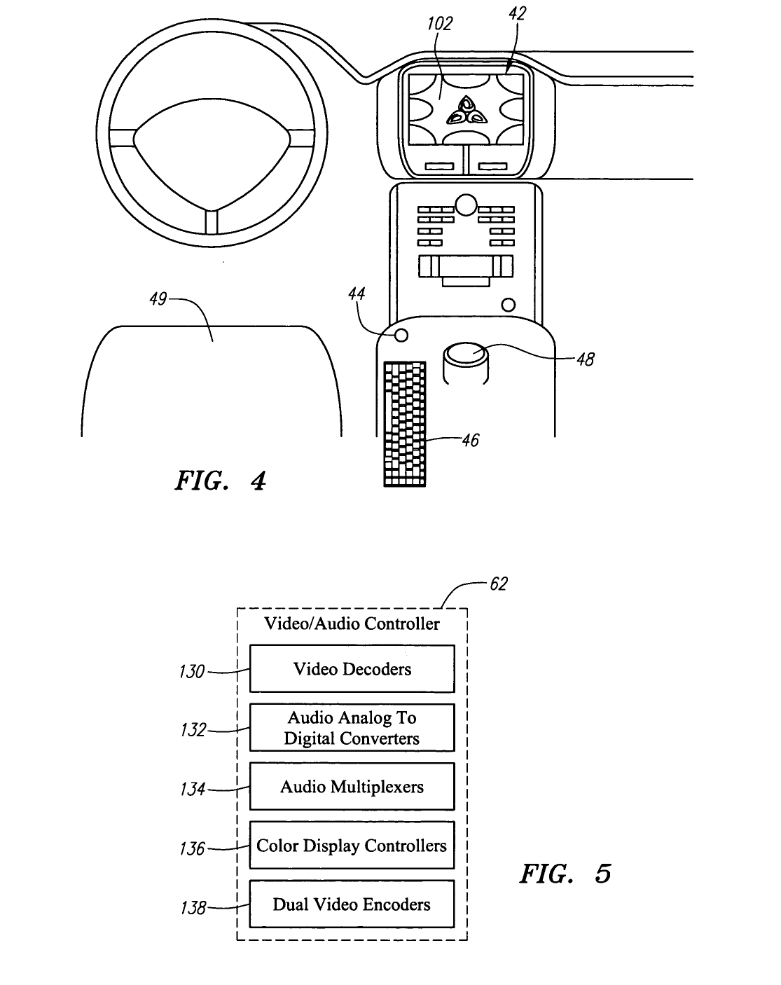

FIG. 4 is a diagram illustrating an interior view in an exemplary vehicle that is equipped with the set up of the exemplary integrated vehicle computer system 10 of FIG. 1. In the embodiment illustrated in FIG. 4, the dashboard monitor 42 with touch screen 102 is located at about the middle of the dashboard. The navigator 48 is located at a lower position on the right side of the driver seat 49. The redial control 44 and the keyboard 46 are also located on the right side of the driver seat 49. The positions of the navigator 48, the redial control 44 and the keyboard 46 can be located elsewhere as long as the driver can operate the mentioned components without having to move in a way that may distract his or her driving.

According to one embodiment, the video/audio capture system 60 of FIG. 1 includes a video/audio controller 62, one or more buttons 64, one or more microphones 66, an event trigger mechanism 68, and one or more cameras 71-77. The video/audio controller 62, the buttons 64, the microphones 66, the event trigger mechanism 68, and the cameras 71-77 each may send and receive signals to/from the embedded processor 22 or the data memory 26 through a wired data bus or cable 54. In one embodiment, the wired data bus or cable 54 is a USB cable. Alternatively, the video/audio controller 62, the buttons 64, the microphones 66, the event trigger mechanism 68, and the cameras 71-77 may be connected to the embedded processor 22 or the data memory 26 through a wireless connection 56. In one embodiment, the wireless connection 56 is a short distance wireless connection.

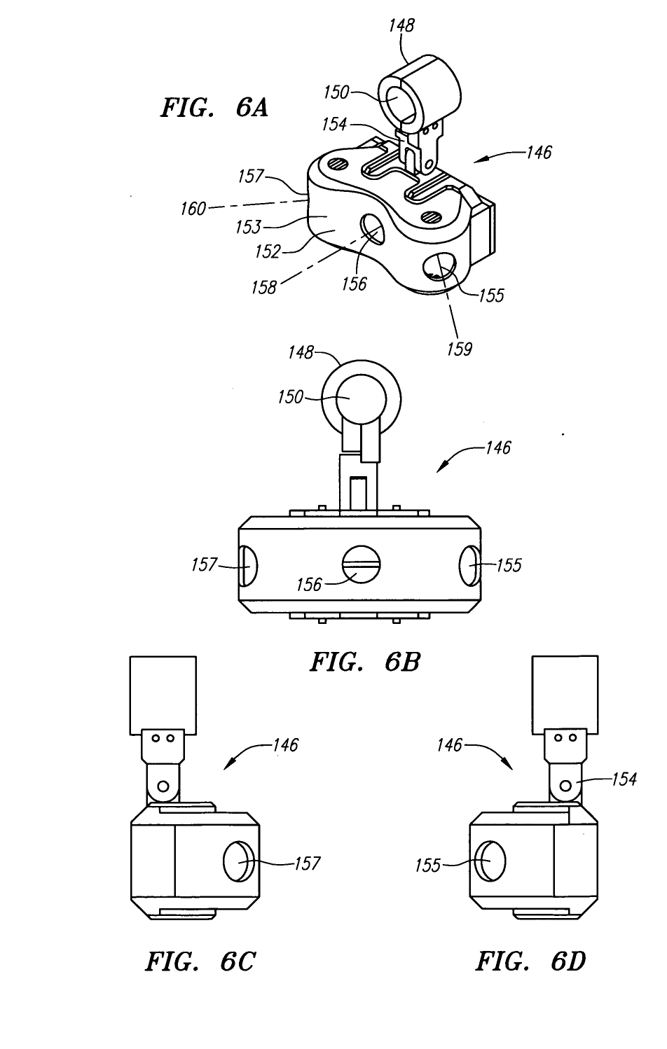

FIG. 5 is a block diagram illustrating system components of the video/audio controller 62 in the video/audio capture system 60 of the exemplary integrated vehicle computer system 10 of FIG. 1. According to one embodiment, the video/audio controller 62 can have one or more video decoders 130, one or more audio analog-to-digital converters 132, one or more audio multiplexers 134, one or more dual color display controllers 136, and one or more dual video encoders 138. The components 130, 132, 134, 136 138 of the video/audio controller 62 may be packaged in discrete forms and mounted on a piece of video/audio controller card. Alternatively, the components of the video/audio controller 62 may be integrated into a single package such as an application-specific integrated circuit.

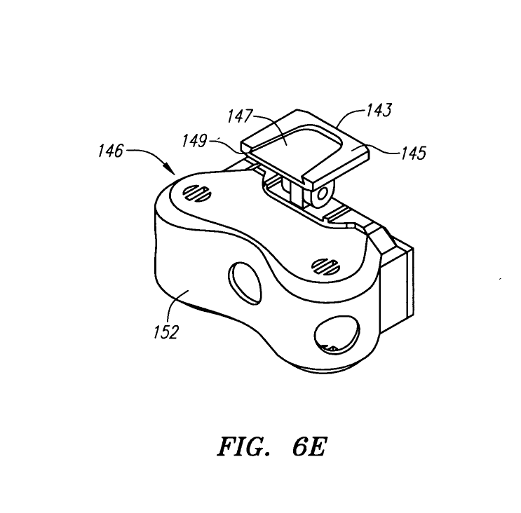

FIG. 6A is a diagram illustrating a perspective view of one embodiment of a camera socket 146 of the exemplary integrated vehicle computer system 10 of FIG. 1. FIG. 6B is a diagram illustrating a front view of the camera socket 146 of FIG. 6A. FIG. 6C is a diagram illustrating a left side view of the camera socket 146 of FIG. 6A. FIG. 6D is a diagram illustrating a right side view of the camera socket 146 of FIG. 6A.

In the embodiment illustrated in FIGS. 6A-D, the camera socket 146 is designed to receive cameras, such as those described previously. The camera socket 146 has a hanger 148, a camera house 152 and a joint 154. The hanger 148 has a hole 150 which can be used to hang the camera socket 146 on the rear mirror of a vehicle. The hanger 148 connects to the camera house 152 through the joint 154. Joint 154 is able to bend 90° so that the face 153 of the camera house 152 is able to be adjusted up and down to face a desired view. The camera house 152 has a right hole 155 which is sized to receive a right camera 71 (not shown). In the same manner, the camera house 152 has a middle hole 156 sized to receive a middle camera 72 (not shown) and a left hole 157 sized to receive a left camera 73 (not shown). Each of the holes 155, 156, 157 has a centerline such that each centerline passes through the center of its corresponding hole and each centerline is perpendicular to the face of its corresponding hole.

In one embodiment, the centerline 158 of the middle hole 156 and the centerline 159 of the right hole 155 form an angle of less than or equal to 90° and greater than or equal to 30° while the centerline 158 of the middle hole 156 and the centerline 160 of the left hole 157 also form an angle of less than or equal to 90° and greater than or equal to 30°. In one embodiment, the centerline 158 of the middle hole 156 and the centerline 159 of the right hole 155 form an angle of 45° while the centerline 158 of the middle hole 156 and the centerline 160 of the left hole 157 form an angle of 45°. In another embodiment, the centerline 158 of the middle hole 156 and the centerline 159 of the right hole 155 form an angle of 60° while the centerline 158 of the middle hole 156 and the centerline 160 of the left hole 157 also form an angle of 60°. Yet in another embodiment, the centerline 158 of the middle hole 156 and the centerline 159 of the right hole 155 form an angle of 75° while the centerline 158 of the middle hole 156 and the centerline 160 of the left hole 157 also form an angle of 75°.

FIG. 6E is a diagram illustrating a perspective view of another embodiment of the camera socket 146 of the exemplary integrated vehicle computer system 10 of FIG. 1. The configuration of the camera house 152 in FIG. 6E can be the same as that in FIG. 6A. A major difference between the embodiments of FIG. 6A and FIG. 6E is that instead of using a hanger 148 as shown in FIG. 6A, FIG. 6E shows a sliding latch 143 that is used to hold the camera socket 146. The sliding latch 143 has a U-shaped top surface 145 and a slide guide slot 147 opened through the top surface 145 to receive a locking tab (not shown) of a flexible mounting mechanism. In this manner, the camera socket 146 of FIG. 6E can be mounted to any area inside or outside of a vehicle. Examples of areas to mount the camera socket 146 include behind the rearview mirror, on the rear window, on the roof of the vehicle, or on the roof rack.

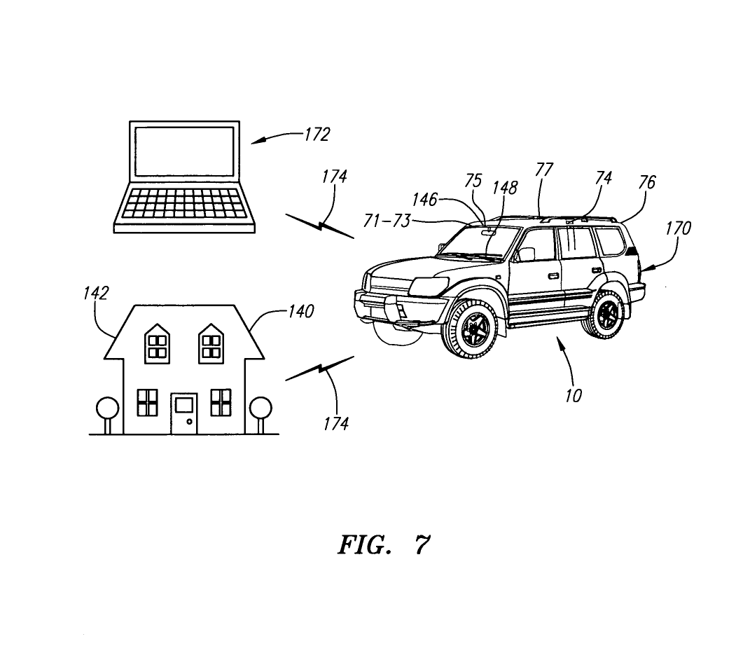

FIG. 7 is a diagram illustrating an exemplary vehicle 170 with the set up of the exemplary integrated vehicle computer system 10 of FIG. 1. In one embodiment, the exemplary vehicle 170 is a passenger vehicle such as a sedan, a wagon, a van or a sport utility vehicle. In another embodiment, the exemplary vehicle 170 is a commercial vehicle such as a truck or a bus. In another embodiment, the exemplary vehicle 170 is a marine vehicle. Yet in another embodiment, the exemplary vehicle 170 is a motorcycle.

In the embodiment illustrated in FIG. 7, the motherboard 20 is placed in the rear end or trunk of the vehicle 170. Alternatively, the motherboard 20 can be placed under the driver seat 49 or other places in the vehicle 170.

According to one embodiment, the cameras 71-77 can be arranged to have three cameras 71-73 set up in the camera socket 146 that is mounted in front of the rear mirror 148 of the vehicle 170 to view a 270° field that covers the front view and partial side views; two side cameras 74, 75 are arranged one on each side of the vehicle 170; and two rear cameras 76, 77 are arranged on the rear end of the vehicle 170. Therefore, with three front cameras 71-73, two side cameras 74, 75 and two rear cameras 76, 77, the 360° view around the vehicle 170 can be captured simultaneously.

In another embodiment (not shown), the camera setting can be arranged to have three cameras set up in a camera socket 146 that is mounted in the front of the vehicle 170 to view a 270° field that covers the front view and partial side views of the vehicle 170; two side cameras are arranged one on each side of the vehicle 170; and three cameras set up in a camera socket 146 that is mounted in the rear of the vehicle 170 to view a 270° field that covers the rear view and partial side views of the vehicle 170. Therefore, with three front cameras, two side cameras and three rear cameras, the 360° view around the vehicle 170 can be captured simultaneously.

In one embodiment, any of the cameras 71-77 can be a digital video recorder. Alternatively, any other types of cameras with continuous recording capability may also be used. In one embodiment, each of the cameras 71-77 is able to continuously record video images and the recorded video images are stored in the data memory 26. In one embodiment, the data memory 26 is sized to store one day, or 24 hours, of video images. In other words, in one embodiment, any piece of video image that is stored in the data memory 26 would not be erased or overwritten within 24 hours when the piece of video image is stored. The memory space in the data memory 26 that stores previously recorded video images older than 24 hours would be overwritten by newly recorded video images. In another embodiment, the data memory 26 is sized to store three days, or 72 hours, of video images and the memory space in the data memory 26 that stores previously recorded video images older than 72 hours would be overwritten by newly recorded video images. In another embodiment, when the memory space is limited, the data memory 26 is used to store a shorter period (i.e., 10 hours) of continuous video images and the user can leave the system 10 off for a period of time and the system 10 can be wake up by a separate computer that is not located in the vehicle.

Unlike other existing in-car accident recorders which can only record a twenty second video clip of an accident triggered by an event, the system 10 makes it possible for the user to retrieve previously recorded video images anytime during the past 24 hours by virtue of its storage system. This ability allows the user to defend himself against false accident claims. This is because there may be other events that may occur more than twenty seconds after an accident and a continuous running video recording can provide relevant information. Further, in some situations, an accident may occur with no direct impact on the vehicle 170 and thus no triggering event. For example, a person changing a spare tire may be hit by another car, or a colleague's vehicle traveling in front of or behind the vehicle 170 may be hit. A continuous recording and saving of video image is helpful for these kind of situations. In another embodiment, the system 10 can be set up as an event triggered mode such that when an event, such as a sudden start or stop, is detected, the system 10 saves a video clip of about ten seconds before the event and ten seconds afterward. Event triggered capability provides the user with a video clip of the incident without examining all video image. In another embodiment, the system 10 can be set up in a mixed mode such that a video image can be saved for 24 hours without overwriting, while a video clip of an incident is also saved in a separate memory space reserved for incident events. In one embodiment, the reserved memory space used to save video images recorded during an incident is sized to receive thirty, twenty-second video clips.

In the embodiment illustrated in FIG. 7, the cameras 71-77 are able to record continuously and the recorded video images can be sent and stored to a remote computer 172, which is not located in the vehicle 170, or sent to a cellular or internet phone through a wireless connection 174. The remote computer 172 can be a home or office personal computer 140 as desired by the user. In another embodiment, the remote computer 172 and the cellular or internet phone can receive notification messages from the system 10 through the wireless connection 174 when the event trigger mechanism detects an incident. Yet in another embodiment, the remote computer 172 and the cellular or internet phone can send an instruction or data to the system 10 through the wireless connection 174 as needed.

In the embodiment illustrated in FIG. 7, the wireless connection 174 is a long distance wireless connection. Some examples of long distance wireless connections are the IEEE 802.11 standards, the wireless local area network, and wireless telephone network.

In one embodiment, the cameras 71-77 can record video images from the surrounding environment of the vehicle 170 and the recorded video images can be sent to the data memory 26 and/or a remote computer 172 even when the car engine is turned off. In one embodiment, the power supply of the exemplary integrated vehicle computer system 10 is the battery of the vehicle 170.

According to one embodiment, the microphones 66 of FIG. 1 are embedded microphones that are able to receive audio messages. The microphones 66 are able to record audio data based on the clock's time or, alternatively, it can start or stop recording audio data based on an event trigger. The audio messages received through the microphones 66 can be synchronized with the cameras 71-77 so that both audio and video image can be recorded and displayed later, as desired.

According to one embodiment, the event trigger mechanism 68 of FIG. 1 utilizes an accelerometer to measure and detect the acceleration and vibrations of the vehicle 170. For example, the accelerometer is able to detect a rapid negative acceleration of the vehicle 170 to determine whenever a collision has occurred. Once a collision or similar event is detected, the exemplary integrated vehicle computer system 10 automatically indicates the time and place of the vehicle and triggers the system 10 to save video images and audio messages. Then, the system 10 notifies the user and, if desired, the police. In the exemplary integrated vehicle computer system 10, a tri-axial accelerometer is used as the event trigger mechanism 68. Alternatively, other accelerometers can also be used.

According to one embodiment, the buttons 64 are set up so that the user can push a button 64 to command each facet of the system 10. For example, one of the buttons 64 can be used to manually start up a process of archiving images captured from the cameras 71-77. The usage of buttons 64 adds the flexibility to the exemplary integrated vehicle computer system 10.

The cameras 71-77, the microphones 66, the event trigger mechanism 68, and the buttons 64 each can be connected to the other components of the video/audio controller 62 via electrical wires or through wireless connections. Also, the whole video/audio capture system 60 and the embedded processor 22 can be connected via electrical wires 54 or through a wireless connection 56. In one embodiment, the wireless connection 56 is a short distance wireless connection.

According to one embodiment, the wireless interface 80 includes a wireless internet card 82 and a wireless router 84. The wireless router 84 can be a wired router with built-in wireless access points so that both of the wired and/or wireless connections are possible at the same time. The wireless router 84 creates a network such that the exemplary integrated vehicle computer system 10 can access to a single broadband connection through the wireless router 84 either wirelessly 88 or through one of its wired ports 86. If a wired connection is set up, an Ethernet adaptor may be required. If a wireless connection is desired, a wireless network adaptor may be required. Both an Ethernet adaptor and a wireless network adaptor may be equipped in the system 10 so that both wired and wireless connections are available.

The wireless internet card 82 may use an antenna to communicate through electromagnetic waves such as microwaves to connect to a radio-based computer network. In one embodiment, the wireless internet card 82 can be a commercial wireless internet card located in a PCI slot or an USB slot of the system 10. The wireless internet card 82 can have an access point so that all data is transferred using the access point as the central hub. In one embodiment, all wireless nodes connect to an access point. Alternatively, the wireless internet card 82 does not require an access point, but rather interfaces with all other wireless nodes directly.

Alternatively, wireless connection can be established through a cellular phone network.

The structure of the exemplary integrated vehicle computer system 10 has been described previously. Some of the features and operations of the exemplary integrated vehicle computer system 10 are described below.

The exemplary integrated vehicle computer system 10 has a single platform with an easily navigated and user friendly interface that brings many desired applications into a simple space. The user focused platform and graphic user interface design promotes driver safety and ease of use. Applications such as the vehicle/driver security system, internet radio, GPS navigation, and even baby/home monitoring, are all at a driver's fingertips.

When the Navigation feature 111 on the touch screen 102 of FIG. 2 is selected, a Global Positioning System (GPS) navigation map is shown on the touch screen 102. The GPS receiver 30 is able to locate the vehicle's location and the location information is sent to human interface 40 through a cable 32 for showing a GPS navigation map.

Beyond providing turn-by-turn voice instructions or touch screen selection, this Navigation feature 111 provides a GPS navigation map that allows greater user interaction, including the ability to zoom in and out of map details with a double touch of the screen 102 or a circular movement around the navigator 48.

Navigation feature 111 also allows for remote manipulation. This feature permits the base office of a delivery company to change a driver's route in order to pick up an unexpected or rush package. A person in the base office may login to the exemplary integrated vehicle computer system 10 located in the driver's vehicle using a computer in the base office, and send destination information for the pickup to the exemplary integrated vehicle computer system 10. In response, the system 10 may display a map that shows the destination and a route so that the driver can change route without personally setting up the new address. The turn-by-turn navigation instruction tells the driver to go from there. This feature eliminate the need for the driver to stop on the road side to write down the address of the new destination and/or enter it into the system 10.

If requested, a delivery person can touch a single button on the touch screen 102 and obtain information such as vehicle location, time, along with an image or a video clip of the collection, which may immediately be transmitted to the home office. Additionally, if desired, the base office can receive driver information and images or video of the vehicle at any other desired times.

Upon selecting Security feature 112 on the touch screen 102 of FIG. 2, the vehicle/driver security screen is displayed. The vehicle/driver security system of the exemplary integrated vehicle computer system 10 is a self-monitoring security system that not only delivers immediate incident notification to the user but also provides security and safety for the user and the user's home or office.

Security feature 112 detects any event that affects the security of the vehicle when the user is not on board. For example, when the vehicle 170 is parked by a road side and the engine is turned off, the exemplary integrated vehicle computer system 10 will detect an accident and immediately notify the user at home, office, or other designated location and provide live video captured from cameras 71-77 to the user. In one embodiment, the live video is shown on the screen of a personal computer at the user's home or office. In another embodiment, the live video is shown on the screen of a cellular phone carried by the user.

Also, with the capability of detecting the turns and speed of the vehicle, the exemplary integrated vehicle computer system 10 would be able to provide a driver statistics and reports to the driver without the involvement of a third-party. This helps protect the privacy of the user.

There is also another unexpected benefit of the exemplary integrated vehicle computer system 10, with the knowledge that the external environment was being visually captured. The driver feels more confident of his safety and the security of the surrounding area, and may drive more safely.

The Security feature 112 allows the user to monitor the situation at his home or office or other places from the touch screen 102. Thus, the exemplary integrated vehicle computer system 10 allows the user to view other external cameras 140 when one of the buttons 64 is pushed. In one embodiment, the external cameras 140 can be set up at the user's home 142. If desired, a user can pan, tilt, and zoom the external cameras 140 from the convenience of his vehicle to view exactly what they want to see. For example, the external camera 140 can be used to monitor activities of children and baby sitters at home, inventory in a warehouse, or workers in an office. In one embodiment, at least one of the external cameras 140 is a real-time video camera whose images can be accessed using the world wide web. Alternatively, the images can be accessed by instant messaging or a PC video calling application. In one embodiment, the video cameras are digital cameras which upload images to a web server, either continuously or at regular intervals. Alternatively, analog cameras can be used (of the sort often used for closed-circuit television). With a video capture card whose output is directly or indirectly connected to the Internet.

Unlike OnStar and DriveCam, the exemplary integrated vehicle computer system 10 is a self-monitoring system that respects the privacy of user by allowing the user to define how the exemplary integrated vehicle computer system 10 should behave, when it should send notification of an incident, and whom should be notified. Third party service centers are not required.

Parents can set their own thresholds for their children and can be notified when a situation exceeds any of these thresholds. In case of an accident, parents may be notified immediately and are able to remotely access the exemplary integrated vehicle computer system 10. The functions of immediate notification, video footage, and two-way communication provide the information needed to help the young driver out of trouble and allay the parents concerns.

The exemplary integrated vehicle computer system 10 is preferably fully functional even when the car is turned off. The self-monitoring features of the exemplary integrated vehicle computer system 10 remains alert, and sends a notification immediately upon detection of an unexpected incident such as automobile theft, door opening, collision, towing, or even movement in a camera's field of view. The exemplary integrated vehicle computer system 10 immediately sends an “unauthorized incident” notice and allows the user to track the vehicle via GPS, watch the camera views from a computer connected to the internet, and even speak to the thieves.

The exemplary integrated vehicle computer system 10 serves as a secure mobile internet hub, that can be used for a variety of purposes including to read and send emails and/or make reservations. If desired, network access and internet can be provided to create an office environment in the vehicle.

When the Power feature 114 on the touch screen 102 of FIG. 2 is selected, a power selection will be shown for the user to set the power behavior of the system 10. For example, when the system 10 is turned off, video captured from cameras 71-77 will not be stored in the data memory 26 or transmitted to a remote computer 172. This feature 114 allows the user to decide in which way the system 10 should be used. If desired, the system 10 can be turned off after a period of time that is set up by the user. This delayed shut down function provides the user the flexibility to leave the vehicle anytime. A sleep mode allows the user to leave the system 10 off for a period of time and the system 10 can be wake up by a separate computer that is not located in the vehicle.

When the Media feature 115 on the touch screen 102 of FIG. 2 is selected, the touch screen 102 displays an MP3 or other digital library and player jack selections. A simple interface allows a user to access a library of songs and other files via the interactive interface. All songs and files are stored within the exemplary integrated vehicle computer system 10 so there are preferably no extra wires or small screens to distract the user.

The exemplary integrated vehicle computer system 10 allows a user to view a video clip or video images for the purpose of entertainment, education or business. For example, when the vehicle 170 is passing through a historic site or a point of interest, the system 10 detects the situation by monitoring the current location of the vehicle 170 from its GPS receiver 30 and a database stored in the system 10. Then, the system 10 activates a search for video images related to the historic site from the video library on board or from the internet. When there is a video image that meets the searching requirements, the system 10 notifies the user that a video is available and inquires whether the user wants to view the video. If the user likes to view the searched video images, it would be displayed on the touch screen 102. Other examples the Media feature 115 include video instructions showing how to empty a tank, change of a tire, or replace a propane tank, which is particular.

When the Radio feature 116 on the touch screen 102 of FIG. 2 is selected, the touch screen 102 displays internet radio and music services selections for the user. The exemplary integrated vehicle computer system 10 platform and interface allows for easy access and navigation of internet based radio stations and provides an opportunity to listen to music tailored to the user's tastes.

In comparison to traditional radio, internet radio is not limited by the distance of broadcasting and the number of channels since a radio station that broadcasts on internet is available to anyone around the world. In the exemplary integrated vehicle computer system 10, the wireless connectivity feeds internet radio and other broadcasts to the vehicle 170 equipped with the system 10. In one embodiment, an internet radio program is played from the speakers equipped in the vehicle 170. In other embodiment, an internet radio program is played from a PDAs carried by a user who is on board the vehicle 170. In other embodiment, an internet radio program is played from a cellular or internet phone carried by a user who is on board the vehicle 170.

With internet music streaming services, the user does not require a huge storage space, downloading, or organizing. In one embodiment, the internet music service in the vehicle 170 allows for the creation of play lists from a library of more than one million songs and can be shared between home, office, and friends.

When the Audio Books feature 117 on the touch screen 102 of FIG. 2 is selected, the touch screen 102 displays audio books selection that allows the user to listen to audio books.

When the Traffic feature 118 on the touch screen 102 of FIG. 2 is selected, the touch screen 102 of the exemplary integrated vehicle computer system 10 displays live traffic or real time traffic grids. A traffic camera is a video camera which observes traffic on a road. Typically, traffic cameras are put along major roads such as highways to capture real-time live traffic information such as an automobile accident or some other disruptive incident. A monitoring center receives the live videos and dispatches them to designated internet sites. In one embodiment, the exemplary integrated vehicle computer system 10 collects a live traffic video from an internet site of a monitoring center and displays the live traffic video on the touch screen 102 when the Traffic 118 feature is selected.

In another embodiment, the system 10 utilizes the location, driving direction, and speed information of the vehicle 170 to predict the route of the vehicle and display on the touch screen 102 a live traffic video captured from a traffic camera which is located at a site along the most likely passing route of the vehicle. The location information of the vehicle 170 can be collected from the GPS receiver 30. When two locations are identified in a short time interval, say five seconds, the information of the driving direction and the speed of the vehicle 170 can then be calculated. In another embodiment, besides showing a site along the most likely passing route of the vehicle, the system 10 displays on the touch screen 102 three live traffic video frames of alternative routes. The video frame of the most likely passing route and the video frames of alternative routes are shown on the touch screen 102 interactively every five seconds. Alternatively, the video frame of the most likely passing route and three video frames of alternative routes can be shrunk to a fourth size and shown together on the touch screen 102. The user can then determine whether an alternate route should be taken.

Besides safety features described previously, the exemplary integrated vehicle computer system 10 also provides other online services while driving, including social network services. A social network service focuses on the building and verifying of online social networks for communities of people who share interests and activities. With the internet access capability, the exemplary integrated vehicle computer system 10 expands the social network service into the vehicle 170 in a safe and easy to use application.

The exemplary integrated vehicle computer system 10 can also be designed to fit in a motorcycle with minor modifications, while providing the same level of security as that in a four wheel vehicle.

The following is a scenario illustrating some benefits of using the exemplary integrated vehicle computer system 10 in a vehicle 170. While a user was driving down a major street, a vehicle A, in front of the user, was rear ended by another vehicle B. Vehicle B immediately left the scene of accident afterward. The driver of vehicle A insisted that the user's vehicle hit vehicle A from behind. System 10 clears up the dispute by providing visual evidence that the user was not at fault, since vehicle B, and possibly the driver of vehicle B, may be seen on the video footage recorded by the system 10, which recorded and saved video images for over 24 hours without overwriting. The final result was that the user assisted the driver of vehicle A by recording and display the incident, at the scene. The user and driver of vehicle A then located vehicle B in a nearby parking lot. Vehicle B was obviously recently damaged, with an airbag deployed. A simple drive could have easily become a legal nightmare—a situation easily avoided with a visual account of what really happened.

The following is another scenario further illustrating the benefits of using the exemplary integrated vehicle computer system 10. A user's vehicle is parked at a mall parking lot. While the user was in the mall for approximately one hour, the exemplary integrated vehicle computer system 10 continued to monitor the vehicle and surrounding environment. The user left the mall parking lot and continued to run errands. Later in the evening someone noticed a large white scratch in the passenger door. The user was able to review the captured video for the day and could see a white car park next to the user's vehicle while in the mall parking lot. The driver of the white car opened his door into the user's vehicle thereby causing the white scratch. The reviewed video shows that the driver hit his door into the car, backed out and drove away quickly. It also shows the driver's appearance and the car's license plate.

Thus, the exemplary integrated vehicle computer system 10 takes full advantage of the mobile computing platform. The exemplary integrated vehicle computer system 10 employs a technical system comprising driver safety, vehicle security, in car entertainment, and the mobile office features to conceive new and useful vehicle processes and apparatuses with a user interface that is easy to navigate. Drivers can enjoy features like vehicle self-monitoring and notification of unexpected incidents—even if the vehicle is in another country, the ignition is turned to the off position, or the car is disabled. Safety and security are brought together in one system that is self-monitoring and runs itself.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting. Indeed, it is contemplated that any combination of features disclosed herein may be combined with any other or combination of other features disclosed herein without limitation.

Furthermore, in describing preferred embodiments, specific terminology is resorted to for the sake of clarity. However, the invention is not intended to be limited to the specific terms so selected, and it is to be understood that each specific term includes all equivalents.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. An integrated vehicle computer system comprising:
a) a motherboard having an embedded processor, a program memory, and a data memory;
b) a GPS receiver;
c) a human interface having a navigator and a dashboard monitor;
d) a wireless interface; and
e) a video capture system having an event trigger mechanism and a plurality of cameras, wherein said cameras continuously record video images, the recorded video images are stored in a memory for more than 24 hours without been overwritten by newly recorded video images.

2. The integrated vehicle computer system of claim 1, wherein said cameras are digital video recorders.

3. The integrated vehicle computer system of claim 1, wherein the previously recorded video images are stored in said data memory.

4. The integrated vehicle computer system of claim 1, wherein the previously recorded video images are stored in a remote computer not located on said vehicle.

5. The integrated vehicle computer system of claim 4, wherein the connection between the integrated vehicle computer system and the remote computer is through a cellular phone network.

6. The integrated vehicle computer system of claim 4, wherein the connection between the integrated vehicle computer system and the remote computer is through one of the IEEE 802.11 standards.

7. The integrated vehicle computer system of claim 1, wherein said navigator has a round top surface to receive pushing or dragging actions from a user.

8. The integrated vehicle computer system of claim 1, wherein said dashboard monitor has a touch screen having a cursor constructed by at least one arrowhead, said arrowhead can be used to point to a desired function selected by a user, wherein said selected function is visually highlighted.

9. The integrated vehicle computer system of claim 1, wherein said event trigger mechanism is a tri-axial accelerometer.

10. The integrated vehicle computer system of claim 1, wherein said integrated vehicle computer system is not powered from a running car engine.

11. The integrated vehicle computer system of claim 1, further comprises a camera socket having a hanger, a camera house, and a joint, said hanger connects to said camera house through said joint, said camera house has at least a middle hole sized to receive a first camera, a right hole sized to receive a second camera and a left hole sized to receive a third camera, said middle hole, right hole, and left hole each has a center line passing through the center of its corresponding hole and perpendicular to the surface of its corresponding hole, the center line of the middle hole and the center line of the right hole form an angle of less than or equal to 90° and greater than or equal to 30°.

12. The integrated vehicle computer system of claim 11, wherein the center line of the middle hole and the center line of the right hole form an angle of 60°.

13. The integrated vehicle computer system of claim 1, wherein said vehicle is able to play internet radio programs.

14. The integrated vehicle computer system of claim 1, further comprises an audio capture system having a microphone to receive audio signals.

15. An integrated vehicle computer system comprising:
a) a motherboard having an embedded processor, a program memory, and a data memory; and
b) a video/audio capture system having an event trigger mechanism and a plurality of cameras, wherein said cameras continuously record video images, the recorded video images are stored in a memory for more than 24 hours without been overwritten by newly recorded video images.

16. The integrated vehicle computer system of claim 15, wherein said cameras are digital video recorders.

17. The integrated vehicle computer system of claim 15, wherein the previously recorded video images are stored in said data memory.

18. The integrated vehicle computer system of claim 15, wherein the previously recorded video images are stored in a remote computer not located on said vehicle.

19. The integrated vehicle computer system of claim 18, wherein the connection between the integrated vehicle computer system and the remote computer is through a cellular phone network.

20. The integrated vehicle computer system of claim 18, wherein the connection between the integrated vehicle computer system and the remote computer is through one of the IEEE 802.11 standards.

21. The integrated vehicle computer system of claim 15, wherein said integrated vehicle computer system is not powered from a running car engine.

22. The integrated vehicle computer system of claim 15, further comprises a camera socket having a hanger, a camera house, and a joint, said hanger connects to said camera house through said joint, said camera house has at least a middle hole sized to receive a first camera, a right hole sized to receive a second camera and a left hole sized to receive a third camera, said middle hole, right hole, and left hole each has a center line passing through the center of its corresponding hole and perpendicular to the surface of its corresponding hole, the center line of the middle hole and the center line of the right hole form an angle of less than or equal to 90° and greater than or equal to 30°.

23. The integrated vehicle computer system of claim 22, wherein the center line of the middle hole and the center line of the right hole form an angle of 60°.

24. A method for providing driving instructions to a driver of a vehicle equipped with an integrated vehicle computer system, the method comprising the steps of:
a) logging in to the integrated vehicle computer system from an electronic device not located on said vehicle through a wireless connection;
b) entering a destination information for said vehicle from said electronic device;
c) sending said destination information to said vehicle through a wireless communication; and
d) displaying said destination information on a touch screen in said vehicle.

25. The method of claim 24, wherein said electronic device is a computer.

26. The method of claim 24 further comprises the steps of:
e) clicking twice on said touch screen to zoom in the destination information previously displayed.

27. A method for providing background information to a driver of a vehicle equipped with an integrated vehicle computer system, the method comprising the steps of:
a) detecting whether the vehicle is passing through a historic site;
b) searching for video images related to the historic site from a video library or internet;
c) inquiring of the user whether the searched video images related to the historic site are to be displayed; and
d) displaying the searched video images related to the historic site on a screen in the vehicle.

28. The method of claim 27 further comprises the steps of:
e) playing audio background information from a speaker in the vehicle.

29. A method for providing live traffic video to a driver of a vehicle equipped with an integrated vehicle computer system, the method comprising the steps of:
a) collecting location information of the vehicle in at least two time intervals;
b) calculating driving direction and speed information of the vehicle according to the collected location information;
c) predicting a likely passing route of the vehicle; and
d) displaying a live traffic video captured from a traffic camera located at the most likely passing route of the vehicle.

30. The method of claim 29 further comprises the steps of:
e) displaying live traffic video frames of alternative routes.

31. A method for self-monitoring of a vehicle equipped with an integrated vehicle computer system, the method comprising the steps of:
a) identifying at least one person who should be notified when an incident occurs;
b) deciding a time period when a notification of said incident should be sent to said person; and
c) sending a notification of said incident to said person after the time period is expired.

32. The method of claim 31, wherein said incident is a collisions of said vehicle.
